(19) United States
(12) Patent Application Publication
(10) Pub. No.: US 2024/0175473 A1
(43) Pub. Date: May 30, 2024

(54) APPARATUS AND METHOD FOR ESTIMATING WEAR OF BRAKE PADS

(71) Applicants: HYUNDAI MOTOR COMPANY, Seoul (KR); KIA CORPORATION, Seoul (KR)

(72) Inventor: Sang Won SON, Seoul (KR)

(73) Assignees: HYUNDAI MOTOR COMPANY, Seoul (KR); KIA CORPORATION, Seoul (KR)

(21) Appl. No.: 18/124,705

(22) Filed: Mar. 22, 2023

(30) Foreign Application Priority Data
Nov. 24, 2022 (KR) 10-2022-0159458

(51) Int. Cl. F16D 66/02; B60Q 5/00; B60Q 9/00; B60T 17/22

(52) U.S. Cl. CPC F16D 66/026; B60Q 5/005; B60Q 9/00; B60T 17/22; F16D 55/226

(57) ABSTRACT

An apparatus of estimating wear of brake pads may include an electric brake configured to adjust a position of a piston using a motor, wherein the piston is configured to generate a friction force by pressing the brake pads onto a disc rotating with a wheel, and a controller electrically connected to the motor and configured to control the motor and estimate a degree of wear of the brake pads based on a required time consumed for the motor to move the piston so that the brake pads press the disc.

### CROSS-REFERENCE TO RELATED APPLICATION(S)

The present application claims priority to Korean Patent Application No. 10-2022-0159458 filed on Nov. 24, 2022, the entire contents of which is incorporated herein for all purposes by this reference.

### BACKGROUND OF THE PRESENT DISCLOSURE

### Field of the Present Disclosure

The present disclosure relates to an apparatus and method for estimating wear of brake pads.

### DESCRIPTION OF RELATED ART

A brake device is a device for stopping a vehicle from moving during braking or parking of the vehicle, and serves to generate a friction force to prevent a wheel of the vehicle from rotating. The brake device includes a hydraulic brake configured to generate a braking force using hydraulic pressure and an electronic brake configured to generate a braking force using a motor. Here, the electronic brake is applied to an electronic parking brake (EPB) that electronically controls the driving of a parking brake.

An electronic brake device presses a disc rotating integrally with the vehicle with a brake pad to generate friction force, braking the vehicle or maintaining the vehicle's stationary state. A brake pad is a consumable product which is worn by friction with the disc during the braking process, and needs to be replaced periodically by checking the degree of wear of the brake pad. A method of checking the degree of wear of the brake pad according to the related art utilizes a principle in which brake pads are disposed between a mechanical wear sensor and a disc, the brake pad and the mechanical wear sensor are integrally moved, and as the brake pad is worn and the thickness of the pads is reduced, a distance between the mechanical wear sensor and the disc is reduced. This is a method of notifying when the brake pad needs to be replaced by generating noise through contact between the disc and the mechanical wear sensor according to the wear of the brake pad, which may cause damage to the disc due to the contact between the wear sensor and the disc, and in the instant case, there may be a problem in that the disc needs to be replaced. Another method is to use an electronic wear sensor, and refers to a method in which when the brake pad is worn, the wire connected to the wear sensor wears together therewith, and when the brake pad is worn beyond a certain level, the wire is detected to be disconnected, thus notifying a user of a notification of replacement of the brake pad. This method may detect the degree of wear without damaging the disc, but costs may increase due to the demand for additional sensors and additional components, such as connectors for connecting the sensors.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for estimating wear of brake pads which can estimate the degree of wear of the brake pads without installing components such as additional sensors.

According to an aspect of the present disclosure, an apparatus of estimating wear of brake pads, the apparatus may include: an electric brake configured to adjust a position of a piston using a motor, wherein the piston is configured to generate a friction force by pressing the brake pads onto a disc rotating with a wheel: and a controller electrically connected to the motor and configured to control the motor and estimate a degree of wear of the brake pads based on a required time consumed for the motor to move the piston so that the brake pads press the disc.

The controller may estimate the degree of wear of the brake pads using a change in a current value of the motor.

The controller may estimate the degree of wear of the brake pads using a time at which the current value of the motor exceeds a predetermined reference value.

The apparatus of estimating wear of brake pads may include a storage unit in which a predetermined first reference time and a predetermined second reference time are stored, and the controller may estimate the degree of wear of the brake pads based on a difference between the required time and the predetermined first reference time and a difference between the required time and the predetermined second reference time.

The predetermined first reference time may be a required time expected by the electronic brake provided with the brake pads in an unworn state, and the predetermined second reference time may be a required time expected by the electronic brake provided with the brake pads which needs to be replaced.

The required time, the predetermined first reference time, and the predetermined second reference time are a time period required until the brake pads press the disc by driving the piston from a furthest distance away from the brake pad.

The apparatus of estimating wear of brake pads may further include a notification unit electrically connected to the controller and configured to notify a user of the degree of wear of the brake pad.

The apparatus of estimating wear of brake pads may further include a transmitter including a communication device configured for transmitting information about the degree of wear of the brake pads to a server.

The apparatus of estimating wear of brake pads may further include a receiver configured to receive a state of a transmission apparatus of a vehicle, and the controller may check the degree of wear of the brake pads when the transmission of the vehicle is in a parking state.

According to another aspect of the present disclosure, a method for estimating wear of brake pads in an electronic brake configured to adjust a position of a piston using a motor and generate a braking force by allowing the piston to move the brake pads and bring the brake pads into contact with the disc may include: checking a required time: and estimating the degree of wear of the brake pads based on the required time, and the required time may be time consumed for the motor to move the piston so that the brake pads press the disc.

The estimating the degree of wear of the brake pads may include estimating the degree of wear of the brake pads by comparing a predetermined first reference time and a predetermined second reference time with the required time, and the predetermined first reference time may be an expected time required by the electronic brake provided with the brake pads in an unworn state, and the predetermined second reference time may be an expected time required by the electronic brake provided with the brake pads which needs to be replaced.

The method for estimating wear of brake pads may further include determining whether to initiate wear estimation of the brake pad, and the determining whether to initiate the wear estimation of the brake pads may include determining whether to initiate the wear estimation of the brake pads based on a state of a transmission gear.

The determining whether to initiate the wear estimation of the brake pads may include initiating the wear estimation of the brake pads in a state in which the transmission gear is placed in a parking state.

The checking of the required time for the brake pads and the disc may include checking the required time based on a change in a current value of the motor.

The checking of the required time may include checking the required time using a time at which a current value of the motor exceeds a predetermined reference value from a time at which a current starts to be applied to the motor.

The method for estimating wear of brake pads may further include notifying the degree of wear of the brake pad, and the degree of wear of the brake pads may be notified using a notification unit including at least one of a display device and an audio device provided in a vehicle.

The method for estimating wear of brake pads may further include notifying the degree of wear of the brake pad, and the degree of wear of the brake pads may be transmitted to a user terminal using a transmitter provided with a communication means.

According to various exemplary embodiments of the present disclosure, because the degree of wear of the brake pads may be checked by estimating the degree of wear of the brake pads without installing components such as additional sensors, costs may be reduced.

Furthermore, because the degree of wear of the brake pads may be checked without mechanical contact between a disc and a sensor, there may be no risk of damage to the disc due to the contact between the disc and the sensor.

Furthermore, because the degree of wear of the brake pads may be checked, the replacement time of the brake pads may be predicted, efficiently managing a vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a block diagram of an apparatus of estimating wear of brake pads according to an exemplary embodiment of the present disclosure.

FIG. 2 is a schematic cross-sectional view of an electronic brake according to an exemplary embodiment of the present disclosure.

FIG. 3A, FIG. 3B, FIG. 3C and FIG. 3D are conceptual views exemplarily illustrating a position of a piston of the electronic brake according to a state of a brake pad.

FIG. 4A, FIG. 4B, and FIG. 4C are conceptual views exemplarily illustrating a state of the electronic brake for measuring a required time, a first reference time, and a second reference time according to an exemplary embodiment of the present disclosure.

FIG. 5 is a graph exemplarily illustrating a method for checking a required time through a current of a motor of the electronic brake according to an exemplary embodiment of the present disclosure.

FIG. 6 is a flowchart of a method for estimating wear of brake pads according to an exemplary embodiment of the present disclosure.

FIG. 7A and FIG. 7B are views exemplarily illustrating a display of a user terminal according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure may make various changes and have various exemplary embodiments of the present disclosure, specific embodiments thereof will be described and illustrated in the drawings. However, the embodiments are not intended for limiting the present disclosure. The idea of the present disclosure should be construed to extend to any alterations, equivalents and substitutes besides the accompanying drawings.

It will be understood that although the terms first, second, etc., may be used herein to describe various elements, these elements should not be limited by these terms. These terms are generally only used to distinguish one element from another. For example, a first element could be termed a second element, and similarly, a second element could be termed a first element, without departing from the scope of the present disclosure. The term of and/or encompasses a combination of plural items or any one of the plural items.

The term used herein is for describing various exemplary embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments of the present disclosure belong. It will be further understood that the terms, such as those defined in commonly used dictionaries, should be interpreted as including meanings that are consistent with their meanings in the context of the relevant art and will not be interpreted in an idealized or overly formal sense unless expressly so defined herein

Hereinafter, various embodiments of the present disclosure will be described with reference to the appended drawings.

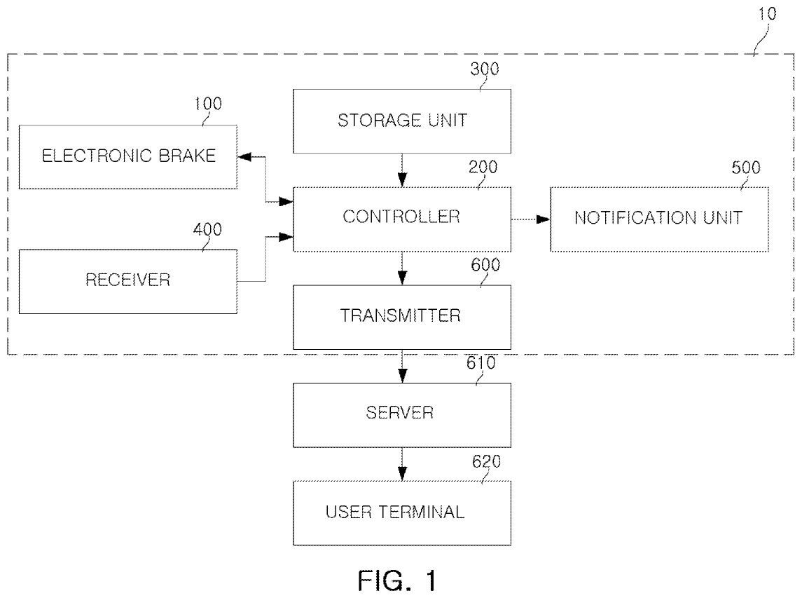

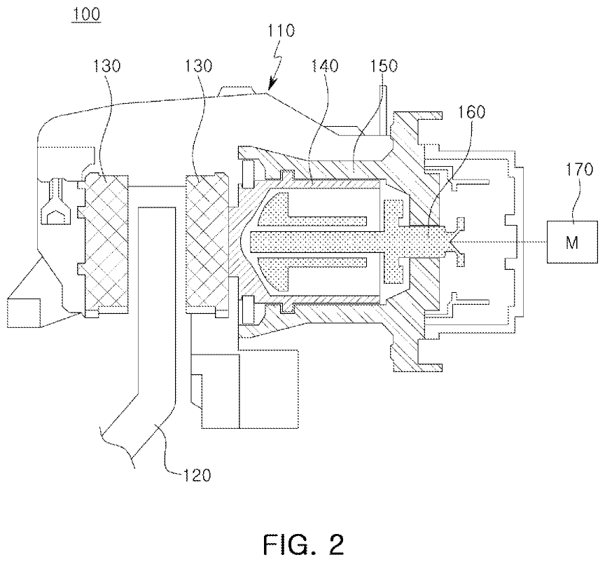

FIG. 1 is a block diagram of an apparatus 10 for estimating wear of brake pads according to an exemplary embodiment of the present disclosure, and FIG. 2 is a schematic cross-sectional view of an electronic brake 100 according to an exemplary embodiment of the present disclosure.

Referring to FIG. 1, the apparatus 10 for estimating wear of brake pads according to an exemplary embodiment of the present disclosure may include the electronic brake 100 and a controller 200.

The electronic brake 100 may be a device configured for generating braking force in a vehicle using a motor 170. Referring to FIG. 2, the electronic brake 100 may include a piston 140 configured to press a brake pad 130 that generates friction force by coming into contact with a disc 120 rotating with a wheel of a vehicle, and a cylinder 150 configured to guide the piston 140 to make a straight movement forwards and backwards thereof. The electronic brake 100 may include a brake pad 130, the piston 140, and a housing 110 configured to support the cylinder 150, a motor 170 configured to generate rotation force, and a power transmission portion 160 configured to receive the rotation force of the motor 170 and move the piston 140 linearly along the cylinder 150.

The brake pad 130 may be mounted in the housing 110 fixed to a vehicle body to move forwards and backwards toward the disc 120. The brake pad 130 may be provided in a side of the disc 120 or may be provided in opposite sides with the disc 120 interposed therebetween.

The housing 110 may include the cylinder 150 and the piston 140, and the piston 140 may perform a linear reciprocating motion and move the brake pad 130 to press the disc 120. The piston 140 may be slidably inserted into the cylinder 150. The piston 140 may receive the rotation force of the motor 170 and press the brake pad 130 toward the disc 120. When a pair of brake pads 130 are provided with the disc 120 interposed therebetween, the piston 140 may receive the rotation force of the motor 170 to press one brake pad 130 toward the disc 120 and press the other brake pad 130 toward the disc 120 by reaction force, generating friction force between the disc 120 and the brake pad 130.

The power transmission portion 160 may receive rotation force from the motor 170 and press the piston 140 toward the brake pad 130. Various components which may move linearly by receiving the rotation force of the motor 170 may be applied to the power transmission portion 160 and various known motors 170 which may generate rotation force may also be applied to the motor 170.

Referring back to FIG. 1, the apparatus 10 for estimating wear of the brake pad according to an exemplary embodiment of the present disclosure may include the controller 200.

The controller 200 may control the motor 170 to adjust the position of the piston 140. Furthermore, the controller 200 may adjust the position of the piston 140 to move the brake pad 130 toward the disc 120, thus checking the degree of wear of the brake pad 130 based on the time consumed until the brake pad 130 presses the disc 120. Here, the time consumed from a driving time of the motor 170 to a time required for the brake pad 130 to press the disc 120 may be referred to as a required time.

The controller 200 may be implemented through an algorithm configured to control operations of various components of the apparatus 10 for estimating wear of brake pads or a nonvolatile memory configured to store data about software a command for playing the algorithm and a processor configured to perform an operation described below, using data stored in the corresponding memory. Here, the memory and the processor may be implemented with individual chips. Alternatively, the memory and the processor may be implemented with a single chip integrated with each other. The processor may take the form of one or more processors.

The storage unit 300 may store the time required until the brake pad 130 presses the disc 120 by moving the brake pad 130 toward the disc 120 using the electronic brake 100 provided with the brake pad 130 in an unworn state. Furthermore, the storage unit 300 may store the time required until the brake pad 130 presses the disc 120, by moving the brake pad 130 toward the disc 120 using the electronic brake 100 provided with the brake pad 130 that needs to be replaced. Here, the required time measured using the brake pad 130 in the unworn state may be referred to as a first reference time, and the required time measured using the brake pad 130 which needs to be replaced may be referred to as a second reference time.

The storage unit 300 is a recording medium suitable for storing a program command and data, including magnetic media such as a hard disk, a floppy disk, and a magnetic tape, optical media such as a compact disk read only memory (CD-ROM), and a digital video disk (DVD), magneto-optical media such as a floptical disk, a semiconductor memory such as a flash memory, an erasable programmable ROM (EPROM), or SSD manufactured based thereon. The program command stored in the storage unit 300 is suitable for implementing a method of estimating wear of the brake pad according to an exemplary embodiment of the present disclosure.

A receiver 400 may check a current state of the vehicle, more specifically, whether the vehicle is started, and a state of a transmission of the vehicle. Furthermore, the receiver 400 may check the current state of the motor 170 of the electronic brake 100. The receiver 400 may transmit state information of the transmission of the vehicle and current information of the motor 170 to the controller 200.

A notification unit 500 may visually or acoustically notify the user of a wear state of the brake pad 130 or a replacement time of the brake pad 130. For example, the notification unit 500 may visually notify the user of the wear state of the brake pad 130 or the replacement time of the brake pad 130 by popping-up a message through a cluster including a display of the vehicle. Furthermore, the notification unit 500 may audibly notify the wear state of the brake pad 130 or the replacement time of the brake pad 130 through sound using an audio device. Furthermore, visual and auditory methods may be applied separately or simultaneously, and especially when the brake pad 130 needs to be replaced, visual and auditory methods may be applied simultaneously to alert the user.

A transmitter 600 may transmit information on the wear state of the brake pad 130 to a server 610 using communication means such as the Internet, LTE, 5G, Wi-Fi, Bluetooth, Near Field Communication (NFC), Zigbee, and a radio frequency (RF). The information on the wear state of the brake pad 130 transmitted from the transmitter 600 may be transmitted to the user through the server 610. The user may check the information on the wear state of the brake pad 130 received by the server 610 by accessing the web using a computer or through an app installed in a user terminal 620.

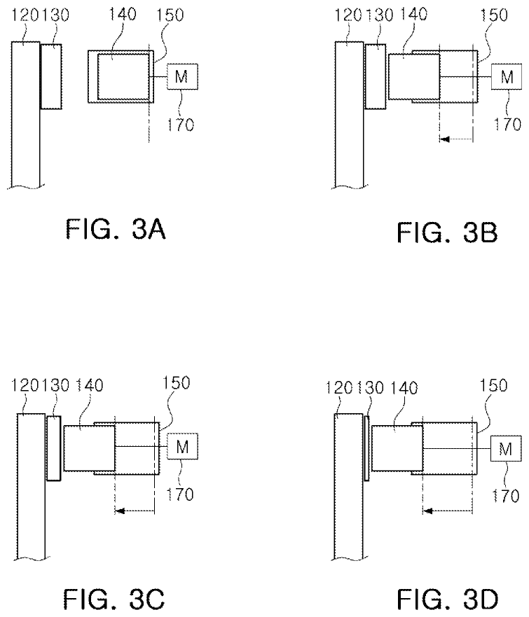

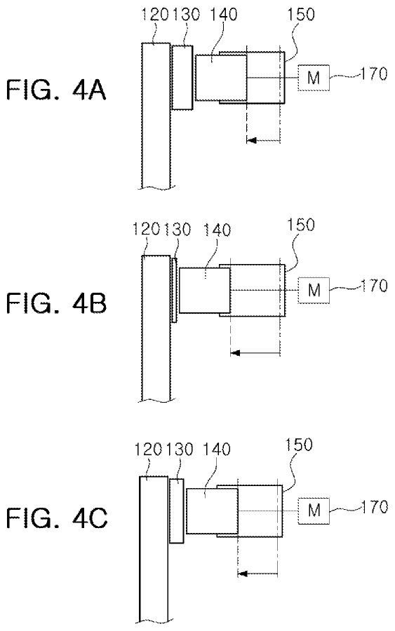

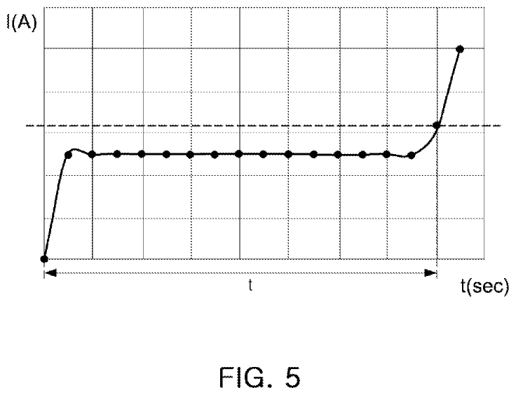

FIG. 3A, FIG. 3B, FIG. 3C and FIG. 3D are conceptual views exemplarily illustrating a position of the piston 140 of the electronic brake 100 according to a state of the brake pad 130, FIG. 4A, FIG. 4B, and FIG. 4C are conceptual views exemplarily illustrating a state of the electronic brake 100 for measuring a required time, a first reference time, and a second reference time according to an exemplary embodiment of the present disclosure, and FIG. 5 is a graph exemplarily illustrating a method for checking a required time through a current of a motor 170 of the electronic brake 100 according to an exemplary embodiment of the present disclosure.

Referring to FIG. 3A and FIG. 3B, when the electronic brake 100 does not operate, the disc 120 and the brake pad 130 may be spaced from each other by a predetermined interval as illustrated in FIG. 3A. When braking force is required, the electronic brake 100 may generate the braking force by moving the piston 140 and pressing the brake pad 130 toward the disc 120, as illustrated in FIG. 3B. Furthermore, as illustrated in FIGS. 3B, 3C and 3D, the brake pad 130 is a consumable component, and as the brake pad 130 is used, it may be worn and become thinner. Furthermore, as illustrated in FIGS. 3B, 3C, and 3D, as a thickness of the brake pad 130 decreases, a moving distance of the piston 140 may change. In other words, as the brake pad 130 is worn, the thickness of the brake pad 130 decreases, and as the moving distance of the piston 140 increases, a driving time of the motor 170 may also be extended. Accordingly, by driving the motor 170 to move the brake pad 130 toward the disc 120, the time required for the brake pad 130 to press the disc 120 may be confirmed to check the wear state of the brake pad 130.

Referring to FIGS. 4A, 4B and 4C, in the case of FIG. 4A, the predetermined first reference time may be checked using the electronic brake 100 provided with the brake pad 130 in an unused, that is, unworn state. As exemplarily illustrated in FIG. 4A, in the electronic brake 100 provided with the brake pad 130 in the unworn state, the brake pad 130 may be moved toward the disc 120 by driving the motor 170 to check the time required for the brake pad 130 to press the disc 120, and the time consumed in the instant case may be referred to as the predetermined first reference time.

In the case of FIG. 4B, the predetermined second reference time may be checked using the electric brake 100 provided with the brake pad 130 which is worn and needs to be replaced. As illustrated in FIG. 4B, in the electronic brake 100 provided with the brake pad 130 which is worn and needs to be replaced, the brake pad 130 may be moved toward the disc 120 by driving the motor 170 to check the time required for the brake pad 130 to press the disc 120. Here, the predetermined first reference time and the predetermined second reference time may be preset through experiments in advance according to the vehicle or the electronic brake 100 and stored in the storage unit 300.

As illustrated in FIG. 4C, the apparatus 10 for estimating wear of brake pads according to an exemplary embodiment of the present disclosure drives the motor 170 to move the brake pad 130 toward the disc 120 and check the time required for the brake pad 130 to press the disc 120. Here, the time required for the brake pad 130 to press the disc 120 may be checked by driving the motor 170 to move the brake pad 130 toward the disc 120, and the time consumed in this may be referred to as the required time.

The controller 200 may check the degree of wear of the brake pad 130 by comparing the required time with the predetermined first reference time and the predetermined second reference time stored in the storage unit 300. When Equation 1 is used, a wear rate of the brake pad 130 may be estimated.

$$Wear Rate ( \% ) = \frac{t - t 1}{t 2 - t 1} \qquad 〈 Equation 1 〉$$

Here, t1 may be a first reference time, t2 may be a second reference time, and t may be a required time.

The user may check the wear rate of the brake pad 130 to maintain and repair the brake pad 130. The apparatus 10 for estimating wear of brake pads according to an exemplary embodiment of the present disclosure may check the current state of the brake pad 130 and predict the replacement time of the brake pad 130 in advance. The apparatus 10 for estimating wear of brake pads according to an exemplary embodiment of the present disclosure can manage the brake pad 130 more efficiently in the case of using a conventional technology which cannot predict when the brake pad 130 needs to be replaced and generates a notification in a state in which the brake pad 130 needs to be replaced.

Referring to FIG. 5, the required time may be checked without a separate sensor by monitoring the current of the motor 170. When the motor 170 operates without load, that is, while the piston 140 moves the brake pad 130 toward the disc 120, the current may remain constant. When a load is applied to the motor 170 (for example, when the brake pad 130 starts to press the disc 120), the current of the motor 170 increases. Accordingly, when the current of the motor 170 flows more than or equal to a preset value, that the brake pad 130 may be determined to press the disc 120. Accordingly, the apparatus 10 for estimating wear of brake pads according to an exemplary embodiment of the present disclosure may measure the required time without an additional sensor, and may estimate the wear rate of the brake pad 130 based on the measured time required.

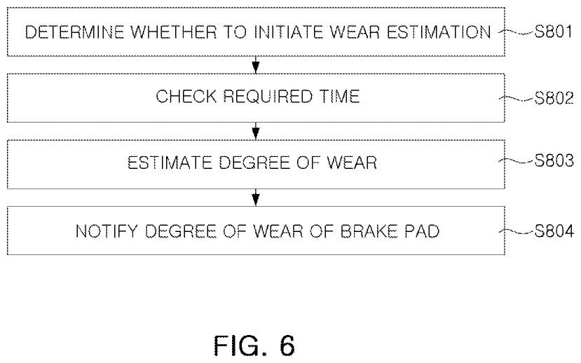

FIG. 6 is a flowchart of a method for estimating wear of brake pads according to an exemplary embodiment of the present disclosure.

Referring to FIG. 6, it may be determined whether to initiate wear estimation of the brake pad according to an exemplary embodiment of the present disclosure (S801). It is possible to estimate the degree of wear of the brake pad 130 without a separate sensor of the present disclosure, but inevitably, a process of pressurizing the disc 120 and the brake pad 130 is involved. Performing the method for estimating wear of brake pads according to an exemplary embodiment of the present disclosure while the vehicle is driving may cause safety problems. Accordingly, it is possible to determine whether to initiate the wear estimation of the brake pad according to an exemplary embodiment of the present disclosure by checking whether the vehicle is stopped. For example, whether the vehicle is stopped may be determined by checking whether the transmission gear of the vehicle is in a parking state. Furthermore, the speed of the vehicle may be recognized to determine whether the vehicle is stopped.

In a state in which the wear estimation of the brake pad according to an exemplary embodiment of the present disclosure may be initiated, the required time may be checked (S802). In the step of checking the required time, the piston 140 may be moved to the farthest position by moving the piston 140 to an opposite side of the brake pad 130. In a state in which the piston 140 is maximally moved to the opposite side of the brake pad 130, the piston 140 may be moved back to the brake pad 130 to press the brake pad 130 and the disc 120. Here, by checking the required time in a state in which the piston 140 is moved to the furthest position by moving the piston 140 to the opposite side of the brake pad 130, all the pistons 140 may start at the same point regardless of the state of the brake pad 130. Without providing a separate sensor, the required time may be measured after moving the piston 140 to the furthest position by moving the piston 140 to the opposite side of the brake pad 130 so that a starting point of the piston 140 remains constant. However, another method which may check the position of the piston 140 and measure the required time in a state in which the piston 140 is always disposed at the same point are also applicable. Furthermore, an exemplary embodiment of the present disclosure is an invention to estimate the degree of wear of the brake pad 130 without an additional sensor, and the degree of wear of the brake pad 130 is estimated using the required time changed in response to the change in the moving distance of the piston 140. However, the present disclosure is not limited thereto, and the degree of wear of the brake pad 130 may be estimated based on the moving distance of the piston 140 using a means that can check the moving distance of the piston 140.

After measuring the required time, the degree of wear may be estimated using the predetermined first and second reference times (S803). The predetermined first reference time and the predetermined second reference time may be preset through experiments in advance. Here, the predetermined first reference time may be a time preset by experimenting with the brake pad 130 in the unworn state, and the predetermined second reference time may be a time preset by experimenting with the brake pad 130 which needs to be replaced. The degree of wear may be estimated through the wear rate, and the wear rate may be confirmed using Equation 1.

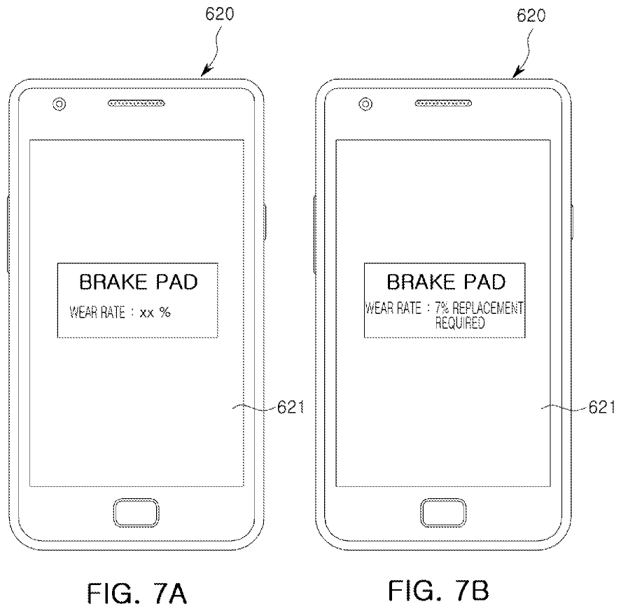

The degree of wear of the brake pad 130 may be notified to the user (S804). For example, a pop-up message may be generated on a display provided in a cluster or a dashboard of the vehicle to visually notify the wear rate of the brake pad 130. Furthermore, the wear rate of the brake pad 130 may be audibly notified through the vehicle's audio device. Furthermore, the estimated wear rate may be transmitted to the server 610 using the transmitter 600 of the vehicle, and the server 610 may transmit the estimated wear rate to the user terminal 620. FIG. 7A and FIG. 7B are views exemplarily illustrating a display screen 621 of the user terminal 620 according to an exemplary embodiment of the present disclosure. As exemplarily illustrated in FIG. 7A, the wear rate of the brake pad 130 may be guided through an app installed in the user terminal 620. The user may predict the replacement time of the brake pad 130 itself through the wear rate of the brake pad 130 and may perform maintenance in advance. Furthermore, as exemplarily illustrated in FIG. 7B, when the wear rate of the brake pad 130 is greater than or equal to a preset rate, a message or notification recommending replacement may be generated.

Methods according to an exemplary embodiment of the present disclosure may be implemented in a form of a program command which may be performed through various computer means and may be recorded in computer-readable medium. The computer-readable media may include, alone or in combination with program commands, data files, data structures, and the like. The program command recorded in the computer-readable media may be specially designed and configured for the present disclosure, or they may be publicly known and available to those including skill in the computer software arts.

Examples of computer-readable media include a hardware device such as ROM, RAM, and a flash memory, which are specifically configured to store and execute the program commands. Examples of program commands include machine language codes made by a compiler, as well as high-level language codes executable by computers, using an interpreter. The above-described hardware device may be configured to operate with at least one software module to perform an operation of the present disclosure, and vice versa.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of estimating wear of brake pads, the apparatus comprising:
an electric brake configured to adjust a position of a piston using a motor, wherein the piston is configured to generate a friction force by pressing the brake pads onto a disc rotating with a wheel; and
a controller electrically connected to the motor and configured to control the motor and estimate a degree of wear of the brake pads based on a required time consumed for the motor to move the piston so that the brake pads press the disc.

2. The apparatus of claim 1, wherein the controller is configured to estimate the degree of wear of the brake pads using a change in a current value of the motor.

3. The apparatus of claim 1, wherein the controller is configured to estimate the degree of wear of the brake pads using a time at which a current value of the motor exceeds a predetermined reference value.

4. The apparatus of claim 1, further including:
a storage unit in which a predetermined first reference time and a predetermined second reference time are stored,
wherein the controller is configured to estimate the degree of wear of the brake pads based on a difference between the required time and the predetermined first reference time and a difference between the required time and the predetermined second reference time.

5. The apparatus of claim 4,
wherein the predetermined first reference time is a predetermined time period expected by the electronic brake provided with the brake pads in an unworn state, and
wherein the predetermined second reference time is a predetermined required time expected by the electronic brake provided with the brake pads which needs to be replaced.

6. The apparatus of claim 1, wherein the required time, the predetermined first reference time, and the predetermined second reference time are a time period required until the brake pads press the disc by driving the piston from a furthest distance away from the brake pad.

7. The apparatus of claim 1, further including a notification unit electrically connected to the controller and configured to notify a user of the degree of wear of the brake pads.

8. The apparatus of claim 1, further including a notification unit electrically connected to the controller and configured to notify a user of wear rate of the brake pads,
wherein the wear rate is determined by the controller using an equation 1:
$$Wear Rate ( \% ) = \frac{t - t 1}{t 2 - t 1} ,$$
wherein t1 is a predetermined first reference time, the t2 is a predetermined second reference time, and the t is the required time.

9. The apparatus of claim 1, further including a transmitter including a communication device electrically connected to the controller and configured for transmitting information about the degree of wear of the brake pads to a server.

10. The apparatus of claim 1, further including:
a receiver configured to receive a state of a transmission apparatus of a vehicle,
wherein the controller electrically connected to the receiver is configured to check the degree of wear of the brake pads when the transmission apparatus of the vehicle is in a parking state.

11. An apparatus of estimating wear of brake pads, the apparatus comprising:
an electric brake configured to adjust a position of a piston using a motor, wherein the piston is configured to generate a friction force by pressing the brake pads onto a disc rotating with a wheel; and
a controller electrically connected to the motor and configured to control the motor and estimate a degree of wear of the brake pads based on a moving distance at which the motor moves the piston until the brake pads press the disc.

12. A method for estimating wear of brake pads in an electronic brake configured to adjust a position of a piston using a motor and generate a braking force by allowing the piston to move the brake pads and be in contact with a disc, the method comprising:
checking, by a controller, a required time; and
estimating, by the controller, degree of wear of the brake pads based on the required time,
wherein the required time is a time period consumed for the motor to move the piston so that the brake pads press the disc.

13. The method of claim 12, wherein the estimating of the degree of wear of the brake pads includes estimating the degree of wear of the brake pads by comparing a predetermined first reference time and a predetermined second reference time with the required time,
wherein the predetermined first reference time is a predetermined time period expected by the electronic brake provided with the brake pads in an unworn state, and the predetermined second reference time is a predetermined required time expected by the electronic brake provided with the brake pads which needs to be replaced.

14. The method of claim 12, further including:
determining, by the controller, whether to initiate wear estimation of the brake pad,
wherein the determining whether to initiate the wear estimation of the brake pads includes determining whether to initiate the wear estimation of the brake pads based on a state of a transmission gear.

15. The method of claim 14, wherein the determining whether to initiate the wear estimation of the brake pads includes initiating the wear estimation of the brake pads in a state in which the transmission gear is placed in a parking state.

16. The method of claim 12, wherein the checking of the required time for the brake pads and the disc includes checking the required time based on a change in a current value of the motor.

17. The method of claim 12, wherein the checking of the required time includes checking the required time using a time at which a current value of the motor exceeds a predetermined reference value from a time at which a current starts to be applied to the motor.

18. The method of claim 12, further including:
notifying the degree of wear of the brake pad, by the controller using a notification unit including at least one of a display device and an audio device provided in a vehicle.

19. The method of claim 12, further including:
notifying, by the controller, the degree of wear of the brake pad,
wherein the degree of wear of the brake pads is transmitted to a user terminal using a transmitter provided with a communication device and electrically connected to the controller.

20. The method of claim 13, further including:
notifying, by a notification unit connected to the controller, a user of wear rate of the brake pads,
wherein the wear rate is determined by the controller using an equation 1:
$$Wear Rate ( \% ) = \frac{t - t 1}{t 2 - t 1} ,$$
wherein t1 is the predetermined first reference time, the t2 is the predetermined second reference time, and the t is the required time.
